(19) United States
(12) Patent Application Publication
(10) Pub. No.: US 2025/0304817 A1
(43) Pub. Date: Oct. 2, 2025

(54) EPOXY COATING FOR FDA APPLICATIONS WITH IMPROVED CURE, FLEXIBILITY AND ADHESION

(71) Applicant: Advanced Polymer Coatings, Inc., Avon, OH (US)

(72) Inventor: Jeremy Pasatta, Olmsted Falls, OH (US)

(21) Appl. No.: 19/095,120

(22) Filed: Mar. 31, 2025

Related U.S. Application Data
(60) Provisional application No. 63/571,473, filed on Mar. 29, 2024.

(51) Int. Cl. C09D 163/00; C08J 7/04; C09D 7/61; C09D 7/63; C09D 7/65

(52) U.S. Cl. CPC C09D 163/00; C08J 7/0427; C09D 7/61; C09D 7/63; C09D 7/65; C08J 2363/00

(57) ABSTRACT

A coating composition includes an epoxy resin (e.g., a bisphenol F-based, bisphenol A-based, and/or novolac-based epoxy resin), an amine curing agent (e.g., an aromatic or cycloaliphatic amine and an amide), ethanol, and benzyl alcohol. A weight ratio of ethanol to benzyl alcohol may be in a range of about 0.28 to about 12. A coating process includes forming the coating composition, depositing the coating composition on a substrate, optionally at least partially drying the deposited coating composition, and curing the coating composition. An article includes a substrate and a coating layer formed from the coating composition.

This application claims the priority benefit of U.S. Provisional Application Ser. No. 63/571,473, filed Mar. 29, 2024, the contents of which are incorporated by reference herein.

### BACKGROUND

It would be desirable to develop new coatings that exhibit improved cure profiles, flexibility and adhesion when using coating components listed in 21 CFR § 175.300 which is incorporated by reference herein.

### BRIEF DESCRIPTION

The disclosure relates to an epoxy-based coating that can be used in FDA approved applications and gives an improved cure profile, flexibility and adhesion while maintaining resistance to commonly stored and transported products in food and beverage applications. Curing may be at ambient temperature or an elevated temperature using amine curing agents.

The improved adhesion comes from the unique combination ratio of benzyl alcohol and ethanol with a low viscosity bisphenol F-based epoxy resin when cured with a combination of isophorone diamine (IPDA) and polyamide. The combination of benzyl alcohol and ethanol in the correct ratio and in the correct amount allows for complete compatibility of the system, and also sufficient flexibility for the IPDA to cure at room temperature, which improves adhesion and decreases the brittleness of the coating.

A coating composition contains a bisphenol F-based epoxy that is cured with a combination of IPDA and polyamide curing agents. The use of both benzyl alcohol and ethanol increases the cure of IPDA, which in turn improves adhesion and flexibility. The ratio of ethanol to benzyl alcohol is critical for both compatibility of the coating before spraying and proper viscosity control of the coating during spraying.

The coating composition may contain any epoxy resin capable of undergoing reaction with an amine curing agent. A particularly useful epoxy resin for this application is a low viscosity bisphenol F-based epoxy resin. The low viscosity bisphenol F resin will ideally have a viscosity less than 4,000 cP as measured by a Brookfield viscometer at 25° C.

Furthermore, the coating may contain a solvent that is suitable for FDA approved applications, such as ethanol. Use of ethanol in an FDA approved coating does not negatively impact the flavor profile of food and beverages stored within a coated vessel. Use of ethanol also allows for further cure of IPDA which decreases the brittleness of the coating and allows for increased adhesion.

Furthermore, the coating will contain benzyl alcohol. Benzyl alcohol improves compatibility between the epoxy resin and ethanol. Benzyl alcohol also allows for further curing with IPDA, which decreases the brittleness of the coating and allows for increased adhesion.

The coating contains one or more amine curing agents. Preferred curing agents are a combination of IPDA, which gives excellent chemical resistance and properties, with a polyamide, which improves flexibility and water resistance of the coating.

In some embodiments, the coating composition contains a filler. Examples include but are not limited to silica (e.g., crystalline silica), barium sulfate and wollastonite.

The coating composition may contain a rheology modifier. Examples include but are not limited to hydrophobic fumed silica.

In some embodiments, the coating contains additional additives such as adhesion promoters, flow and levelling additives and pigments for coloration and hiding.

The coating may be capable of curing at room temperature in less than 12 hours. Alternatively, the coating can be cured with heat to improve properties.

Further disclosed are processes for applying a coating. The processes include depositing a coating composition containing the composition described, optionally at least partially drying the coating composition, and curing the epoxy resin.

Disclosed, in some embodiments, is a coating composition containing: an epoxy resin; an amine curing agent; benzyl alcohol; and ethanol.

In some embodiments, the coating composition further includes at least one additive selected from the group consisting of fillers, pigments, and rheology modifiers. The filler may include silica, barium sulfate, and/or wollastonite.

In some embodiments, the pigment contains titanium dioxide.

The rheology modifier may include fumed silica.

In some embodiments, the epoxy resin is a bisphenol F-based epoxy resin, a bisphenol A-based epoxy resin, and/or a novolac-based epoxy resin.

In particular embodiments, the epoxy resin comprises a bisphenol F-based epoxy resin.

The amine curing agent may contain a cycloaliphatic amine, an aromatic amine, and/or a polyamide.

In some embodiments, the amine curing agent contains isophorone diamine and a polyamide.

A weight ratio of the ethanol to benzyl alcohol may be in a range of about 0.28 to about 12, about 0.8 to about 4.5, 1.4 to about 3, or about 1.61.

In some embodiments, the epoxy resin has a viscosity of less than 5,000 cP, less than 4,000 cP, or less than 3,000 cP measured at 25° C.

The coating composition may be formed from a coating composition kit including: (A) a first part containing: the epoxy resin, ethanol, and benzyl alcohol; and (B) a second part containing: a polyamide curing agent; and a cycloaliphatic amine curing agent or an aromatic amine curing agent.

One or more of the aforementioned additives may be included in either or both of parts (A) and (B).

In some embodiments, part (B) contains from about 10 to about 34 wt % of the polyamide curing agent and from about 64 to about 92 wt % of the cycloaliphatic curing agent; or from about 15 to about 29 wt % of the polyamide curing agent and from about 69 to about 87 wt % of the cycloaliphatic curing agent; or from about 20 to about 24 wt % of the polyamide curing agent and from about 74 to about 82 wt % of the cycloaliphatic curing agent.

Part (A) may contain from about 20 to about 60 wt % of the epoxy resin, from about 2 to about 12 wt % of the ethanol and from about 1 to about 7 wt % of the benzyl alcohol; or from about 30 to about 50 wt % of the epoxy resin, from about 5 to about 9 wt % of the ethanol, and from about 2 to about 6 wt % of the benzyl alcohol; or from about 35 to about 45 wt % of the epoxy resin, from about 6 to about 8 wt % of the ethanol; and from about 3 to about 5 wt % of the benzyl alcohol.

In some embodiments, part (A) further includes from about 20 to about 60 wt % filler, from about 4 to about 12 wt % pigment, and from about 0.2 to about 1.6 wt % rheology modifier; or from about 30 to about 50 wt % filler, from about 6 to about 10 wt % pigment, and from about 0.6 to about 1.4 wt % rheology modifier; or from about 35 to about 45 wt % filler, from about 7 to about 9 wt % pigment, and from about 0.8 to about 1.2 wt % rheology modifier.

Disclosed, in other embodiments, is a coating process including: forming a coating composition by mixing the first part (A) and the second part (B) of the coating composition kit; and curing the coating composition.

The coating composition may be cured on a substrate.

Mixing may occur prior to, during, and/or after deposition onto the substrate.

Deposition methods include but are not limited to airless spray deposition and plural component spray deposition.

Coated articles including food packaging are also disclosed.

These and other non-limiting characteristics are more particularly described below.

### BRIEF DESCRIPTION OF THE DRAWINGS

FIG. 1 is a flow chart illustrating a non-limiting example of a coating process in accordance with some embodiments of the present disclosure.

FIG. 2 is a side cross-sectional view of a coated article in accordance with some embodiments of the present disclosure.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure relates to a coating composition containing an epoxy resin cured with a combination of IPDA and polyamide, which has a unique level of ethanol and benzyl alcohol that allows for compatibility between epoxy resin and ethanol, increased cure of IPDA resulting in increased adhesion and flexibility, and a viscosity and formulation such that it can be applied by both airless spray and plural component spray.

The coating composition uses an epoxy resin that has both good chemical resistance and also a viscosity that is low enough to allow for a minimum of solvent addition and allows for application by both airless spray and plural component spray. Examples of this type of epoxy resin include low viscosity bisphenol F-based resins. Viscosity of these resins should be less than 5,000 cP as measured on a Brookfield viscometer at 25° C., and preferably less than 3,000 cP as measured on a Brookfield viscometer.

The coating composition may be provided in two parts, A and B. Providing the composition in parts A and B may have advantages such as avoiding premature reactions. Non-limiting examples of compositions for parts A and B are provided in Tables 1 and 2 below.

TABLE 1
Non-Limiting Examples for Part A

| | | Broad | Intermediate | Narrow |
|---|---|---|---|---|
| Component | Example | (wt %) | (wt %) | (wt %) |
| Low viscosity | Epotec YDF | 20-60 | 30-50 | 35-45 |
| bisphenol F | 172 LV | | | |
| based epoxy | | | | |
| resin | | | | |
| Solvent | Ethanol | 2-12 | 5-9 | 6-8 |
| Filler | Cimbar XF | 0-60 | | |
| | (barium | or | | |
| | sulfate) | 20-60 | 30-50 | 35-45 |
| Pigment | TR90 Titanium | 0-12 | | |
| | Dioxide | or | | |
| | | 4-12 | 6-10 | 7-9 |
| Rheology | Aerosil 300 | 0-1.6 | | |
| Modifier | (fumed silica) | or | 0.6-1.4 | 0.8-1.2 |
| | | 0.2-1.6 | | |
| Accelerator | Benzyl alcohol | 1-7 | 2-6 | 3-5 |

TABLE 2
Non-Limiting Examples for Part B

| | | Broad | Intermediate | Narrow |
|---|---|---|---|---|
| Component | Example | (wt %) | (wt %) | (wt %) |
| Polyamide | Ancamide 220 | 10-34 | 15-29 | 20-24 |
| curing agent | | | | |
| Cycloaliphatic | Vestamin IPD | 64-92 | 69-87 | 74-82 |
| amine curing | | | | |
| agent | | | | |

Ratio of A: B will depend on the amine and epoxy used, this will dictate stoichiometry. A: B ratio can also depend on filler and solvent level. The level of curing agent is normally done at a level much lower than stoichiometric due to the presence of latent curing agents, which are used at a catalytic amount. Typical levels of curing agents based on the representative compositions given in Table 1 are 100 parts by weight of Part A to 11.5 to 15.5 parts by weight of Part B.

Parts A and B are not limited to the specific materials or types of materials discussed above.

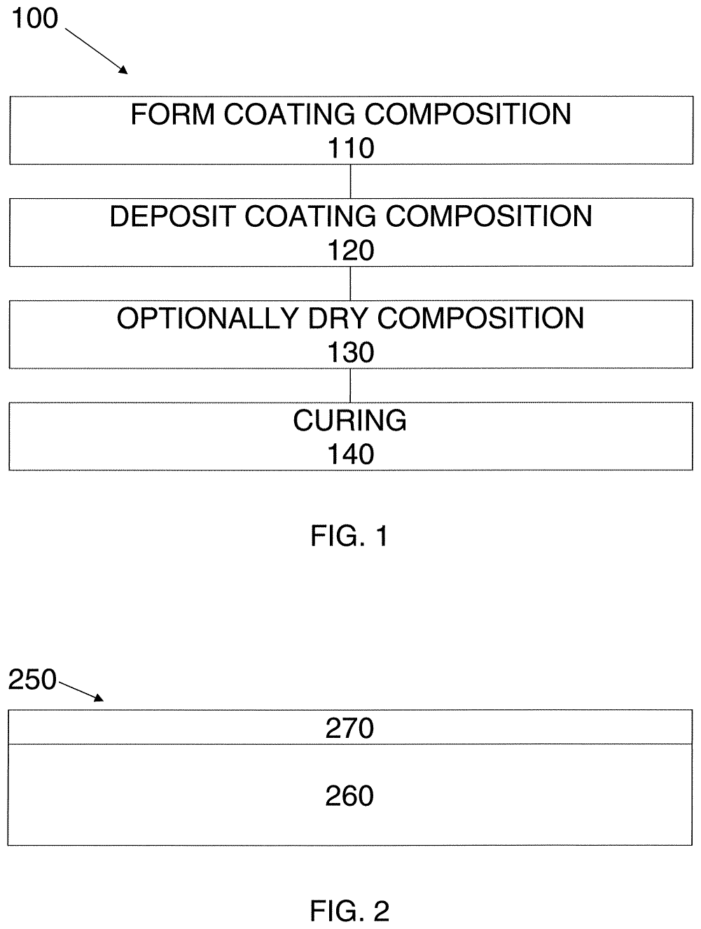

FIG. 1 is a flow chart illustrating a non-limiting example of a coating process 100 in accordance with some embodiments of the present disclosure. The process 100 includes forming a coating composition 110, depositing the coating composition on a substrate 120, optionally at least partially drying the composition 130, and curing the deposited coating composition 140.

In some embodiments, the coating composition is formed 110 by mixing a first part (A) and a second part (B).

The coating composition may be deposited 120 on the substrate using any suitable application step. In particular embodiments, airless spray application and/or plural component spray application is/are used.

It should be noted that one or more steps may be repeated to form a coating with a desired thickness.

FIG. 2 is a side cross-sectional view of a coated article 250 in accordance with some embodiments of the present disclosure. The article includes a substrate 260 with a coating layer 270 deposited thereof. The substrate 260 may be a monolayer or a multilayer substrate. The substrate may be made of a metal or a metal alloy. In some embodiments, the substrate comprises steel. The metal(s) may be selected from Li, Be, Na, Mg, Al, K, Ca, Sc, Ti, V, Cr, Mn, Fe, Co, Ni, Cu, Zn, Ga, Rb, Sr, Y, Zr, Nb, Mo, Tc, Ru, Rh, Pd, Ag, Cd, In, Sn, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, TI, Pb, Bi, Po, Fr, Ra, Ac, Th, Pa, Np, Pu, Am, Cm, Bk, Cf, Es, Fm, Md, No, Lr, Rf, Db, Sg, Bh, Hs, Mt, Ds, Rg, Cn, Nh, FI, Mc, and Lv. The coating layer 270 is formed from the coating composition described herein and may be formed in a single coating or multiple coatings.

The following examples are provided to illustrate the devices and methods of the present disclosure. The examples are merely illustrative and are not intended to limit the disclosure to the materials, conditions, or process parameters set forth therein.

### Examples

### EXAMPLE 1: COATING COMPOSITION CONTAINING NOVEL EPOXY DILUENT

TABLE 3
PART A

| COMPONENT | AMOUNT (parts by weight) |
|---|---|
| Epotec YDF 172 LV | 39.6 |
| Ethanol | 7.1 |
| Cimbar XF (barium sulfate) | 39.6 |
| TR90 Titanium Dioxide | 7.9 |
| Aerosil 300 (fumed silica) | 1.3 |
| Benzyl alcohol | 4.4 |

Epotec YDF 172 LV, ethanol and benzyl alcohol are combined in a suitable container equipped with a Cowles mixing blade. The components are stirred until homogeneous, approximately 5 minutes. The stirring rate is then increased and the Cimbar XF is slowly added, and this mixture is allowed to stir at high shear rates for 10-15 minutes. After this time, the titanium dioxide is added and allowed to stir at high shear rates for 2-3 minutes. The Aerosil 300 is then added, and the mixture is allowed to stir at high shear rates for 10 minutes.

TABLE 4
PART B

| COMPONENT | AMOUNT (parts by weight) |
|---|---|
| Ancamide 220 | 20 |
| Vestamin IPD | 70.3 |

Vestamin IPD and Ancamide 220 are added to a mixing vessel equipped with a Cowles type mixing blade and allowed to mix until homogeneous.

Part A and Part B are then thoroughly combined to give a coating composition capable of being applied via airless spray with the following properties:

| | | |
|---|---|---|
| Gel time (Shyodu gel timer) | 32 | min |
| Sag resistance | 60 | mil+ |
| Linear Dry Time | 7.5 | hours |

The coating was mixed at 100 parts by weight of Part A and 13.6 Parts by weight of Part B and was drawn down in a 15-mil film and cured for 3 days at ambient temperature. After 3 days at ambient temperature the film was easily removed from a MYLAR® (biaxially-oriented polyethylene terephthalate) substrate and was able to be bent around a 3-inch curvature without breaking. When coated onto a blasted steel panel and allowed to cure for 3 days at ambient temperature, the direct impact resistance was greater than 160 in-lbs. In contrast, when similar formulations are prepared without the ethanol and benzyl alcohol, the coating cannot be removed from the MYLAR® substrate without cracking due to the brittle nature, and when coated on a blasted steel panel, the direct impact resistance is <20 in-lbs.

The coating compositions of the present disclosure optionally utilize one or more additional materials described in 21 CFR § 175.300.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A coating composition comprising:
an epoxy resin;
an amine curing agent;
benzyl alcohol; and
ethanol.

2. The coating composition of claim 1, further comprising at least one additive selected from the group consisting of fillers, pigments, and rheology modifiers.

3. The coating composition of claim 2, wherein the filler comprises silica, barium sulfate, and/or wollastonite; and/or wherein the pigment comprises titanium dioxide; and/or wherein the rheology modifier comprises fumed silica.

4. The coating composition of any one of claim 1, wherein the epoxy resin comprises a bisphenol F-based epoxy resin, a bisphenol A-based epoxy resin, and/or a novolac-based epoxy resin.

5. The coating composition of any one of claim 1, wherein the amine curing agent comprises a cycloaliphatic amine, an aromatic amine, and/or a polyamide.

6. The coating composition of any one of claim 1, wherein the amine curing agent comprises isophorone diamine and a polyamide.

7. The coating composition of any one of claim 1, wherein a weight ratio of the ethanol to benzyl alcohol is in a range of about 0.28 to about 12.

8. The coating composition of any one of claim 1, wherein the epoxy resin has a viscosity of less than 5,000 cP measured at 25° C.

9. A coating composition kit comprising:
(A) a first part comprising:
an epoxy resin;
ethanol;
benzyl alcohol; and
(B) a second part comprising:
a polyamide curing agent; and
a cycloaliphatic amine curing agent or an aromatic amine curing agent.

10. The coating composition kit of claim 9, wherein the first part (A) and/or the second part (B) further comprises at least one additive selected from the group consisting of fillers, pigments, and rheology modifiers.

11. The coating composition kit of claim 9, wherein part (B) comprises from about 10 to about 34 wt % of the polyamide curing agent and from about 64 to about 92 wt % of the cycloaliphatic curing agent.

12. The coating composition kit of claim 9, wherein part (B) comprises from about 15 to about 29 wt % of the polyamide curing agent and from about 69 to about 87 wt % of the cycloaliphatic curing agent.

13. The coating composition kit of claim 9, wherein part (A) comprises from about 20 to about 60 wt % of the epoxy resin, from about 2 to about 12 wt % of the ethanol;
and from about 1 to about 7 wt % of the benzyl alcohol.

14. The coating composition kit of claim 9, wherein part (A) comprises from about 30 to about 50 wt % of the epoxy resin, from about 5 to about 9 wt % of the ethanol;
and from about 2 to about 6 wt % of the benzyl alcohol.

15. The coating composition kit of claim 9, wherein the epoxy resin comprises a bisphenol F-based epoxy resin, a bisphenol A-based epoxy resin, and/or a novolac-based epoxy resin.

16. The coating composition kit of claim 9, wherein the epoxy resin comprises a bisphenol F-based epoxy resin.

17. The coating composition kit of claim 9, wherein the cycloaliphatic amine curing agent comprises isophorone diamine.

18. A coating process comprising:
forming a coating composition by mixing the first part (A) and the second part (B) of the coating composition kit of claim 9; and
curing the coating composition.

19. The coating process of claim 18, wherein the coating composition is cured on a substrate.

20. The coating process of claim 18, wherein the coating composition is formed in situ on the substrate.
